(19) United States
(12) Patent Application Publication
(10) Pub. No.: US 2017/0048757 A1
(43) Pub. Date: Feb. 16, 2017

(54) USER EQUIPMENT IN MOBILE COMMUNICATION SYSTEM AND METHOD FOR CONTROLLING THE SAME

(71) Applicants: Yong LEE, Gyeonggi-do (KR); Prasad Basavaraj DANDRA, Bangalore (IN); Vijay Ganesh SURISETTY, Bangalore (KR); Srinivas CHINTHALAPUDI, Bangalore (KR); Jae Kyu LEE, Seoul (KR)

(72) Inventors: Yong LEE, Gyeonggi-do (KR); Prasad Basavaraj DANDRA, Bangalore (IN); Vijay Ganesh SURISETTY, Bangalore (KR); Srinivas CHINTHALAPUDI, Bangalore (KR); Jae Kyu LEE, Seoul (KR)

(73) Assignee: Samsung Electronics Co., Ltd.

(21) Appl. No.: 15/093,364

(22) Filed: Apr. 7, 2016

(30) Foreign Application Priority Data
Aug. 13, 2015 (KR) 10-2015-0114467

(51) Int. Cl. H04W 36/00

(52) U.S. Cl. CPC H04W 36/0011; H04W 36/0061

(57) ABSTRACT

A user equipment (UE) and method for controlling the UE are provided. The UE includes a memory configured to store network identification information, the network identification information including information about a Radio Access Technology (RAT) corresponding to a type of a network; and a communication device comprising a transceiver, and a processor configured to control the transceiver, in response to a network reselection event while the UE is connected to a first network, to connect the UE to a second network based on the network identification information.

### PRIORITY

This application claims priority under 35 U.S.C. §119(a) to Korean Patent Application Serial No. 10-2015-0114467, which was filed in the Korean Intellectual Property Office on Aug. 13, 2015, the entire disclosure of which is incorporated herein by reference.

### BACKGROUND

1. Field of the Disclosure

The present disclosure relates generally to a User Equipment (UE) and method for controlling the UE in a mobile communication system, and more particularly, to a UE and method for controlling the UE to prevent service delays in re-selection of a network in a mobile communication system.

2. Description of the Related Art

A UE may receive roaming services from a mobile communication system, e.g., a 3rd Generation Partnership Project (3GPP) or Long Term Evolution (LTE) system.

In providing a roaming service, a network operator identification number, such as Public Land Mobile Network (PLMN) and/or Equivalent Public Land Mobile Network (EPLMN) may be used. For example, the UE may be capable of performing an inter-PLMN handover, wherein a PLMN that may be considered equivalent to a PLMN registered (or stored) in the UE is referred to as an equivalent PLMN (EPLMN).

FIG. 1 is signal flow diagram illustrating a conventional roaming service.

Referring to FIG. 1, roaming services for a 3G network offered by a network operator B are agreed (or contracted) between a network operator A and the network operator B. Herein, a network operator may be referred to using different names, such as “network provider”, “communication company”, etc.

Further, a network service offered by the network operator A, a network service offered by the network operator B, and a network service offered by the network operator C may be referred to as “network A”, “network B”, and “network C”, respectively.

Referring to FIG. 1, network operator A is a default network operator for a UE 100.

In operation 105, the UE 100 sends an attachment and a Tracking Area Update REQuest (TAU REQ) message for the network operator A in order to access a 2G network 110 of the network A.

In operation 115, the UE 100 receives Tracking Area Update ACCept (TAU ACC) message in response to the TAU REQ message.

The UE 100 accesses the 2G network 110 of the network A through operations 105 and 115. The UE 100 may receive an EPLMN list from the network A, e.g., a management server of the network A, and store the EPLMN list in operation 115.

While communication is performed via the 2G network 110 of the network A, a network reselection event occurs in operation 125. For example, the network reselection event may include an instance where reselection (or rescanning or transition) of Radio Access Technology (RAT) is required because the UE 100 moves out of the coverage area of the network A.

In response to the reselection event, the UE 100 sends a Request for Routing Area Update (RAU REQ) message to a 3G network 120 of the network B in operation 135.

In response, in operation 145, the UE 100 receives an RAU acceptance (ACC) message from the network B. Through operations 135 and 145, the UE 100 accesses the 3G network 120 of the network B. Operations 135 and 145 may be performed based on the EPLMN stored in the UE 100.

While communication is performed via the 3G network 120 of the network B, a network reselection event occurs in operation 155.

In response to the network reselection event, the UE 100 sends a request for attachment to the 2G network 130 of the network B, e.g., RAU REQ message, in operation 165. However, because there is no agreement on the 2G network of the network operator B between the network operator A and the network operator B, the UE 100 receives an attachment rejection (RAU REJ) message from the network B, in operation 175.

Accordingly, the UE 100 scans and selects a new PLMN in operation 185, in order to access another network, different from the network B.

FIG. 2 is signal flow diagram illustrating a conventional roaming service.

In FIG. 2, roaming services for a 3G network offered by a network operator B are agreed between a network operator A and the network operator B. Also, roaming services for 2G and 3G networks offered by the network operator A are agreed between the network operator A and the network operator B.

Referring to FIG. 2, a default network of a UE 200 is the network B.

The UE 200 accesses a 3G network 220 of the network A through an attachment request in operation 205 and an acceptance in operation 215.

In operation 225, a network reselection event occurs while the UE 200 is connected to the 3G network 220 of the network A.

In response to the network reselection event, the UE 200 accesses a 2G network 230 of the network A through attachment request in operation 235 and an acceptance in operation 245.

In operation 255, a network reselection event occurs while the UE 200 is connected to the 2G network 230 of the network A.

In response to this network reselection event, in operation 265, the UE 200 sends a request for attachment to an LTE network 210 of the network A to the network A. However, because roaming services only for the 2G network 230 and 3G network 220 offered by the network operator A are agreed between the network operator A and the network operator B, the UE 200 receives an attachment rejection message from the network A in operation 275.

Accordingly, the UE 200 scans and selects a new PLMN in operation 285, in order to access another network, different from the network A.

As described above, conventional technologies do not allow a UE to be aware of an agreement between different network operators because network identification information, such as an EPLMN, does not include information about the agreement. Consequently, as illustrated in FIGS. 1 and 2, when the UE 100 or 200 sends a request for attachment to a RAT for which no agreement is made, the UE 100 or 200 receives a rejection messages, e.g., in operation 175 or 275, and a delay is caused in the process of scanning and selecting a new PLMN in order to access a new network, e.g., in operation 185 or 285.

### SUMMARY

Accordingly, an aspect of the present disclosure is to provide a communication device that prevents a delay in scanning and selecting a new PLMN by blocking (or not attempting) attachment to a RAT for which no agreement is made between network operators in offering a roaming service.

Another aspect of the present disclosure is to provide a method for controlling a communication device to prevent a delay in scanning and selecting a new PLMN by blocking attachment to a RAT for which no agreement is made between network operators in offering a roaming service.

Another aspect of the present disclosure also provide a User Equipment (UE) that prevents a delay in scanning and selecting a new PLMN by blocking attachment to a RAT for which no agreement is made between network operators in offering a roaming service.

In accordance with an aspect of the present disclosure, a communication device in a mobile communication system is provided. The communication device includes a memory configured to store network identification information, the network identification information including information about a Radio Access Technology (RAT) corresponding to a type of a network; a transceiver; and a processor configured to control the transceiver, in response to a network reselection event while the communication device is connected to a first network, to connect the communication device to a second network based on the network identification information.

In accordance with another aspect of the present disclosure, a method for controlling a communication device in a mobile communication system is provided. The method includes identifying a network reselection event while the communication device is connected to a first network; and requesting attachment to a second network based on network identification information stored in the communication device, in response to the network reselection event. The network identification information includes information about a Radio Access Technology (RAT) corresponding to a type of a network.

In accordance with another aspect of the present disclosure, a UE is provided. The UE includes a memory configured to store network identification information, the network identification information including information about a Radio Access Technology (RAT) corresponding to a type of a network; and a communication device comprising: a transceiver; and a processor configured to control the transceiver, in response to a network reselection event while the UE is connected to a first network, to connect the UE to a second network based on the network identification information.

In accordance with another aspect of the present disclosure, a system on chip (SoC) for use in a user equipment (UE) in a mobile communication system is provided. The SoC includes a memory configured to store network identification information, the network identification information including information about a Radio Access Technology (RAT) corresponding to a type of a network; a transceiver; and a processor configured to control the transceiver, in response to a network reselection event while the UE is connected to a first network, to connect the UE to a second network based on the network identification information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1 and 2 are signal flow diagrams illustrating conventional roaming services;

FIG. 3A illustrates a communication device according to an embodiment of the present disclosure;

FIG. 3B illustrates a User Equipment (UE) including a communication device according to an embodiment of the present disclosure;

FIG. 4 is a signal flow diagram illustrating operations to prevent a delay in reselecting a network according to an embodiment of the present disclosure;

FIG. 5 is a signal flow diagram illustrating operations to prevent a delay in reselecting a network according to an embodiment of the present disclosure;

FIG. 6 is a signal flow diagram illustrating operations to prevent a delay in reselecting a network according to an embodiment of the present disclosure;

FIG. 7 is a signal flow diagram illustrating operations to prevent a delay in reselecting a network according to an embodiment of the present disclosure;

FIG. 8 is a signal flow diagram illustrating operations to prevent a delay in reselecting a network according to an embodiment of the present disclosure; and

FIG. 9 is a flowchart illustrating a method for controlling a UE, according to an embodiment of the present disclosure.

Throughout the drawings, like reference numerals may be understood to refer to like parts, components, and structures.

### DETAILED DESCRIPTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Terms as used herein are merely used for the purpose of explaining some embodiments of the present disclosure and are not intended to limit the present disclosure to the embodiments.

Herein, terms such as “have”, “having”, “comprise”, “comprising”, etc., specify the presence of disclosed functions, operations, or components, but do not preclude the presence or addition of one or more other functions, operations, or components.

The terms “A or B”, “at least one of A and/or B”, or “one or more of A and/or B” include any and all combinations of one or more of the associated listed items, i.e., A and B. For example, “A or B”, “at least one of A and B”, or “at least one of A or B” may indicate (1) at least A, (2) at least B, or (3) at least A and at least B.

Numerical terms such as “first”, “second”, etc., may be used to indicate various components, but the components should not be restricted by these terms. These terms are used to distinguish an element, component, region, layer, or section from another element, component, region, layer, or section. For example, a first UE and a second UE refers to different UEs, irrespective of their order or importance. For example, the first UE may be referred to as the second UE, and vice versa, within the scope of the present disclosure.

When a component (e.g., a first component) is operatively or communicatively coupled with/to or connected to another component (e.g., a second component), the first component may be directly connected or coupled to the second component, or the first component may be indirectly connected or coupled to the second component via another component (e.g., a third component). However, if the first component is “directly connected” or “directly coupled” to the second component, there is no component between these two components.

Herein, “configured to” may be interchangeably used with “suitable for”, “having the capacity to”, “designed to”, “adapted to”, “made to”, or “capable of” according to context. The expression “configured to” may not necessarily mean “specifically designed to” in terms of hardware, but may mean “able to cooperate with” under a certain situation. For example, “a processor configured to perform A, B, and C functions” may refer to a dedicated processor, e.g., an embedded processor for performing A, B, and C functions, or a general purpose processor, e.g., a Central Processing Unit (CPU) or an application processor (AP), which may perform A, B, and C functions by executing one or more software programs stored in a memory.

Singular forms, such as “a”, “an”, and “the” are intended to include the plural forms as well, unless the context clearly indicates otherwise.

All terms including technical and scientific terms used herein have the same meaning as commonly understood by one of ordinary skill in the art to which this disclosure belongs. It will be further understood that terms, such as those defined in commonly used dictionaries, should be interpreted as having meanings that are consistent with their definitions in the context of the relevant art and will not be interpreted in an idealized or overly formal sense unless expressly so defined herein.

Herein, a “communication device” may refer to a unit including one of hardware, software, and firmware, or a combination thereof. The communication device may be interchangeably used with other various terms, e.g., a communication unit, a communication logic, a communication logical block, a communication component, or a communication circuit. For example, the communication device may be referred to as a modem or modem chip. The communication device may be a minimum unit or part of an integrated component of electrical device. The communication device may be a minimum unit or part of performing one or more functions. The communication device may be mechanically or electrically implemented. For example, the communication device may include at least one of Application Specific Integrated Circuit (ASIC) chips, Field Programmable Gate Arrays (FPGAs), or Programmable Logic Arrays (PLAs) that perform some operations, which have already been developed or will be developed in the future.

A communication device may be operated while being equipped (or arranged or included) in a UE. The UE may include a smart phone, a tablet Personal Computer (PC), a mobile phone, a video phone, an e-book reader, a desktop PC, a laptop PC, a netbook computer, a workstation, a server, a Personal Digital Assistant (PDA), Portable Multimedia Player (PMP), an MP3 player, a mobile medical device, a camera, and a wearable device. Examples of the wearable device may include an accessory type device (e.g., a watch, a ring, a bracelet, an anklet, a necklace, glasses, contact lenses, or a Head-Mounted Device (HMD)), cloth or a clothing type device (e.g., electronic clothing), a body-attachable device (e.g., a skin pad or a tattoo), and an implantable circuit.

Herein, the term “user” may refer to a person or device, e.g., an artificially intelligent device, that uses the communication device or the UE.

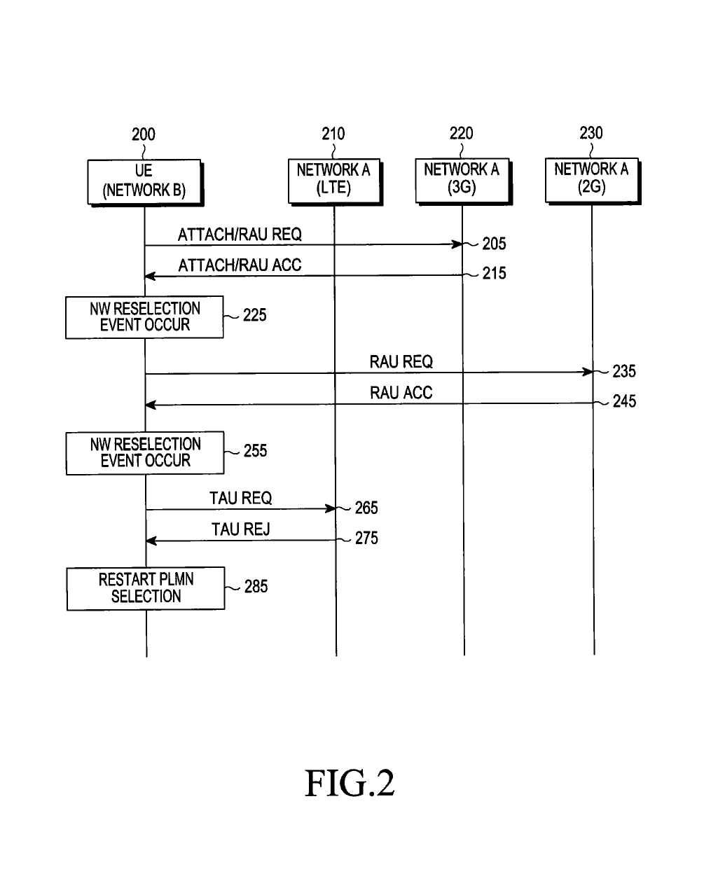

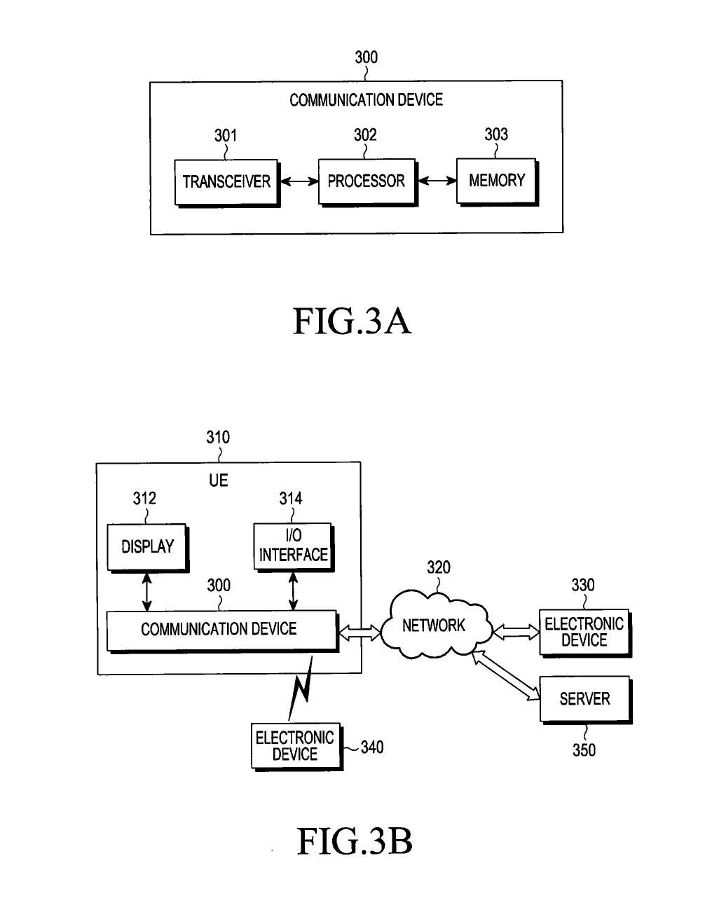

FIG. 3A illustrates a communication device according to an embodiment of the present disclosure, and FIG. 3B illustrates a UE including a communication device, according to an embodiment of the present disclosure.

Referring to FIG. 3A, the communication device 300 includes a transceiver 301, a processor 302, and a memory 303. The communication device 300 may be embodied as a system on chip (SoC) or an integrated circuit.

The transceiver 301 may establish communication between the communication device 300 and an external device, e.g., a first external electronic device 330, a second external electronic device 340 or a server 350 as illustrated in FIG. 3B. For example, the transceiver 370 may be connected to a network 320 through wired or wireless communication and may communicate with the external device. The transceiver 301 may also be referred to as a communication module or communication interface.

Examples of the wireless communication include a cellular communication protocol and short-range communication. For example, the cellular communication protocol may be Long-Term Evolution (LTE), LTE-Advanced (LTE-A), Code Divisional Multiplexing Access (CDMA), Wideband CDMA WCDMA, Universal Mobile Telecommunications System (UMTS), Wireless Broadband (WiBro), Global System for Mobile Communications (GSM), etc. The short-range communication may be Wireless Fidelity (Wi-Fi), Bluetooth, Near Field Communication (NFC), Global Navigation Satellite System (GNSS), etc. The GNSS may include Global Positioning System (GPS), Global Navigation Satellite System (Glonass), Beidou Navigation Satellite System or Galileo System, and the European global satellite-based navigation system.

Examples of the wired communication may include Universal Serial Bus (USB), High Definition Multimedia Interface (HDMI), Recommended Standard (RS) 232, and Plain Old Telephone Service (POTS). The network 320 may include at least one of telecommunication networks, e.g., computer networks (e.g., Local Area Network (LAN) or Wide Area Networks (WAN)), the Internet, and telephone networks.

The processor 302 may include a Communication Processor (CP). The processor 302 may further include one or more of CPUs and/or APs. The processor 302 may perform operation or data processing related to control and/or communications of at least one of the other components of the communication device 300. Herein, the term “processor” may be interchangeably used with other terms like a control module, a control unit, or a controller.

The memory 303 may include volatile and/or nonvolatile memories. The memory 303 may store commands or data related to at least one of the other components of the communication device 300. The memory 303 may store software and/or a program, which may include a kernel, middleware, an Application Programming Interface (API), and/or application programs (or applications). While the memory 303 is illustrated as being included in the communication device 300 in FIG. 3A, the present disclosure is not limited to this example. For example, the memory 303 may be separately manufactured from the communication device 300.

Referring to FIG. 3B, a UE 310 includes the communication device 300, a display 312, and an input/output (I/O) interface 314.

For example, the display 312 may include a Liquid Crystal Display (LCD), a Light Emitting Diode (LED) display, an organic LED (OLED) display, Micro-Electromechanical System (MEMS) display, an electronic paper display, etc. The display 312 may display various content, e.g., text, images, video, icons, symbols, etc. The display 312 may include a touch screen that detects touch, gesture, proximity and/or hovering inputs from an electronic pen or a body part of the user.

The I/O interface 314 may serve as an interface to deliver commands or data input from the user or an external device to other component(s) of the UE 310. The I/O interface 314 may also output commands or data received from the other components of the UE 310 to the user or other external devices.

Although not illustrated, the UE 310 may further include a storage module, e.g., a memory, or a processor, e.g., an AP.

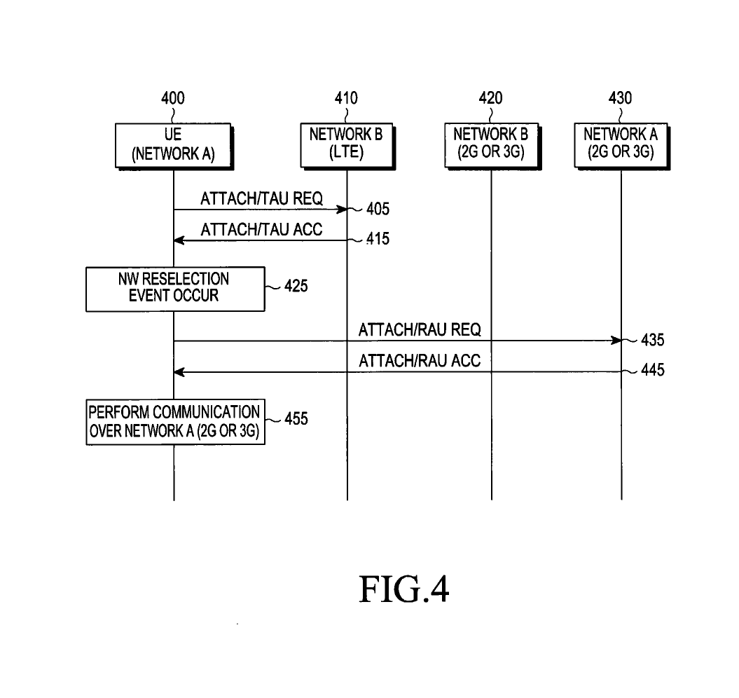

FIG. 4 is a signal flow diagram illustrating operations to prevent a delay in reselecting a network according to an embodiment of the present disclosure. Specifically, FIG. 4 illustrates operations to prevent a delay in reselecting a network by offering a roaming service based on RAT information included in network attachment information.

Herein, the network identification information may include a network attachment list, network attachment information, a network block list, or network block information. The network attachment list may include an EPLMN list, which is information for a UE to access a network. The EPLMN list may include PLMN IDs (or PLMN identification numbers) to identify at least one network operator. Herein, the term “LTE network” may also refer to LTE-A and beyond LTE (5G).

Referring to FIG. 4, in operation 405, a communication device of a UE 400 controls the UE 400 to send an attachment and Tracking Area Update REQuest (ATTACH/TAU REQ) message to an LTE network 410 of a network B. For example, the request in operation 405 may be sent when a change of a network operator or change of a particular RAT provided by the network operator is required because the UE 400 has moved out of the coverage of a network A, e.g., under a roaming service.

A network attachment list may be provided by the network operator A or the network operator B. The network attachment list may include identification numbers for identifying network operators, such as PLMN ID information, e.g., “45005” of the network B, and information about network types for which roaming agreements have been made between the network operator A and the network operator B, among one or more network types, e.g., LTE, UMTS, GMS, etc., offered (or supported) by the network B. In FIG. 4, for example, a roaming agreement is made between the network operators A and B for the LTE network 410 offered by the network operator B.

In operation 415, the UE 400 receives a response (Tracking Area Update ACCeptance (ATTACH/TAU ACC) message from the LTE network 410 of the network B. Operation 415 may be controlled and/or performed by the transceiver.

Because a roaming agreement is made between the network operators A and B for the LTE network 410 of the network B, the network B may send the response message in operation 415, which accepts the request made by the UE 400 in operation 405. Through operations 405 and 415, the UE 400 performs communication over the LTE network 410 of the network B, e.g., using the communication device therein.

During communication over the LTE network 410 of the network B, a network reselection event occurs for the UE 400 in operation 425. For example, the network reselection event may occur when reselection (or rescanning or transition) of a RAT is required because the UE 400 moves out of the coverage area of the network B.

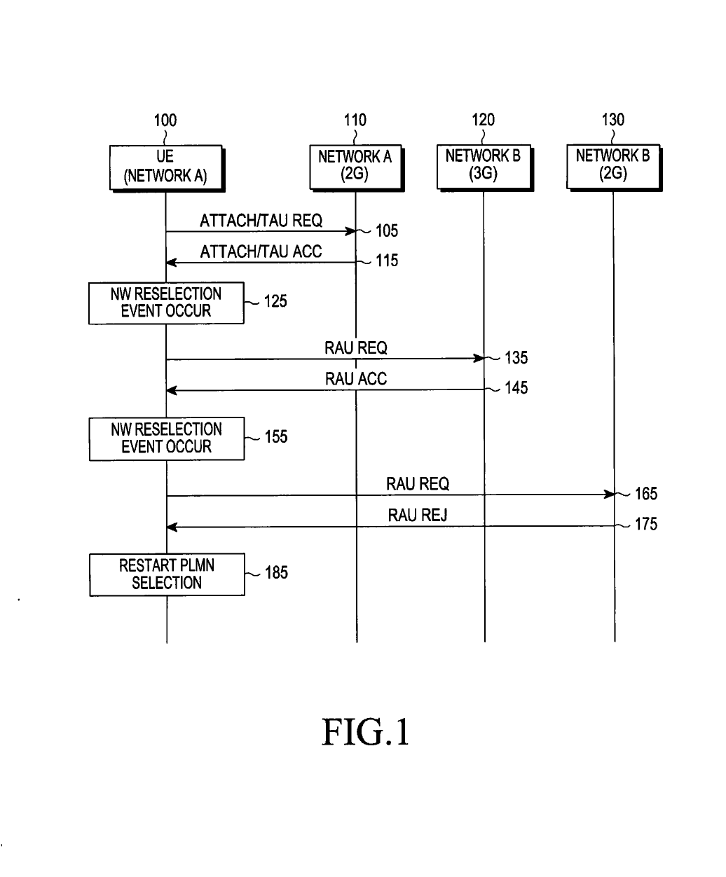

When the network reselection event occurs in operation 425, the communication device of the UE 400 controls the UE 400 to reselect a network based on the network attachment list stored in a storage module (e.g., the memory 303 or a memory included separately from the communication device in the UE 400). Specifically, the communication device of the UE 400 controls the UE 400 to send an attachment and Tracking Area Update REQuest (ATTACH/TAU REQ) message to a 2G or 3G network 430 of the network A in operation 435. In accordance with an embodiment of the present disclosure, the communication device of the UE 400 controls the UE 400 not to request registration to a 2G or 3G network 420 of the network B, but instead, to request registration to the 2G or 3G network 430 of the network A included in the network attachment list, even if the PLMN IDs are the same, because the LTE network 410 of the network B is included in the network attachment list. That is, network reselection for the 2G or 3G network 420 of the network B is blocked, e.g., by the processor 302 of the communication device 300. Accordingly, instead of a delay that occurs in network reselection in the conventional scheme, e.g., as illustrated in FIGS. 1 and 2, in FIG. 4, by receiving the EPLMN list that includes RAT information and PLMN IDs from the network operator A or network operator B, the UE 400 knows not to attempt registration to the 2G or 3G network 420 of the network B.

In operation 445, the UE 400 receives an acceptance response (ATTACH/RAU ACC) message.

In operation 455, the UE 400 performs communication over the 2G or 3G network 430 of the network A.

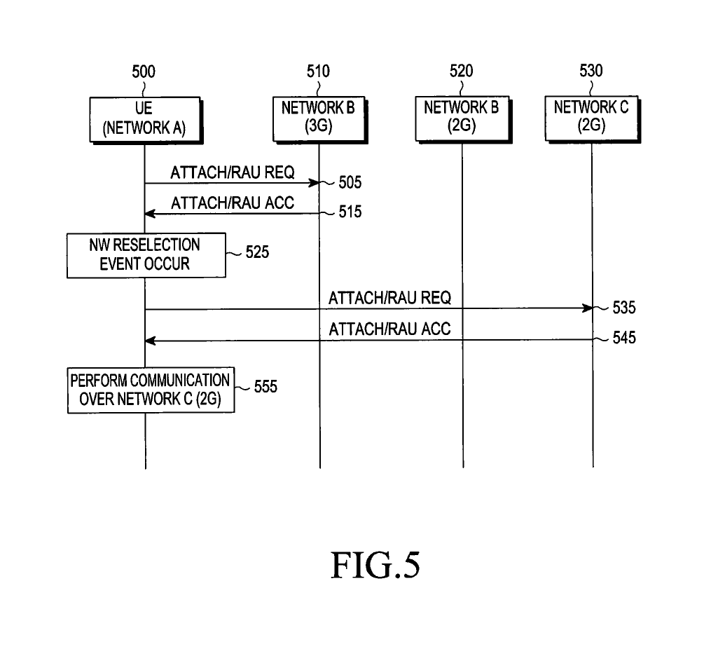

FIG. 5 is a signal flow diagram illustrating operations to prevent a delay in reselecting a network according to an embodiment of the present disclosure. In FIG. 5, a roaming agreement is made for a 3G network, e.g., a UMTS, between network operators A and B, and a roaming agreement is made for a 2G network, e.g., the GSM, between network operators A and C.

Referring to FIG. 5, a communication device, e.g., the communication device 300, of a UE 500 controls the UE 500 to send a registration request (ATTACH/RAU REQ) message for a 3G network 510 of the network B, to the network B, in operation 505.

In operation 515, the UE 500 receives an acceptance response (ATTACH/RAU ACC) message from the network B.

After the acceptance response is received in operation 515, a network reselection event occurs in operation 525.

After the network reselection event occurs in operation 525, in operation 535, the communication device of the UE 500 controls the UE 500 to send a registration request (ATTACH/RAU REQ) message for a 2G network 530 of the network C included in the network attachment list, according to the roaming agreements. In operation 545, because of the roaming agreements, the UE 500 receives an acceptance response (ATTACH/RAU ACC) message from the network C.

In operation 555 the UE 500 communicates over the 2G network 530 of the network C.

Because of the roaming agreements, the UE 500 knows not to attempt registration to the 2G network 520 of the network B, thereby preventing a delay that would result from first requesting registration thereto.

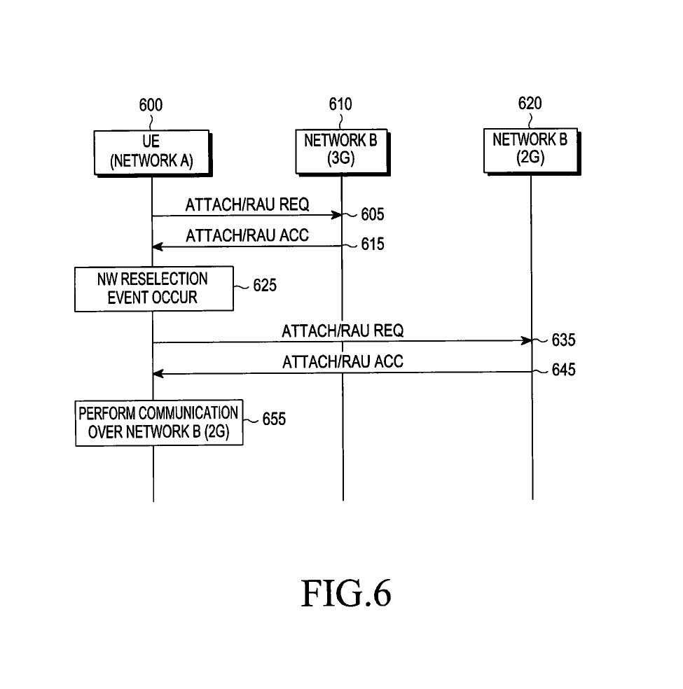

FIG. 6 is a signal flow diagram illustrating operations to prevent a delay in reselecting a network according to an embodiment of the present disclosure. In FIG. 6, roaming agreements are made between network operators A and B for a 3G network, e.g., the UMTS, and a 2G network, e.g., the GSM.

Referring to FIG. 6, a communication device, e.g., the communication device 300, of a UE 600 controls the UE 600 to send a registration request (ATTACH/RAU REQ) message for a 3G network 610 of the network B to the network B, in operation 605.

In operation 615, the UE 600 receives an acceptance response (ATTACH/RAU ACC) message from the network B.

After the acceptance response is received in operation 615, a network reselection event occurs for the UE 600 in operation 625.

After the network reselection event occurs in operation 625, according to the roaming agreement, the UE 600 sends a registration request (ATTACH/RAU REQ) message for a 2G network 620 of the network B included in the network attachment list in operation 635.

According to the roaming agreement, the UE 600 receives an acceptance response (ATTACH/RAU ACC) message from the 2G network 620 of the network B in operation 645.

In operation 655, the UE 600 communications over the 2G network 620 of the network B.

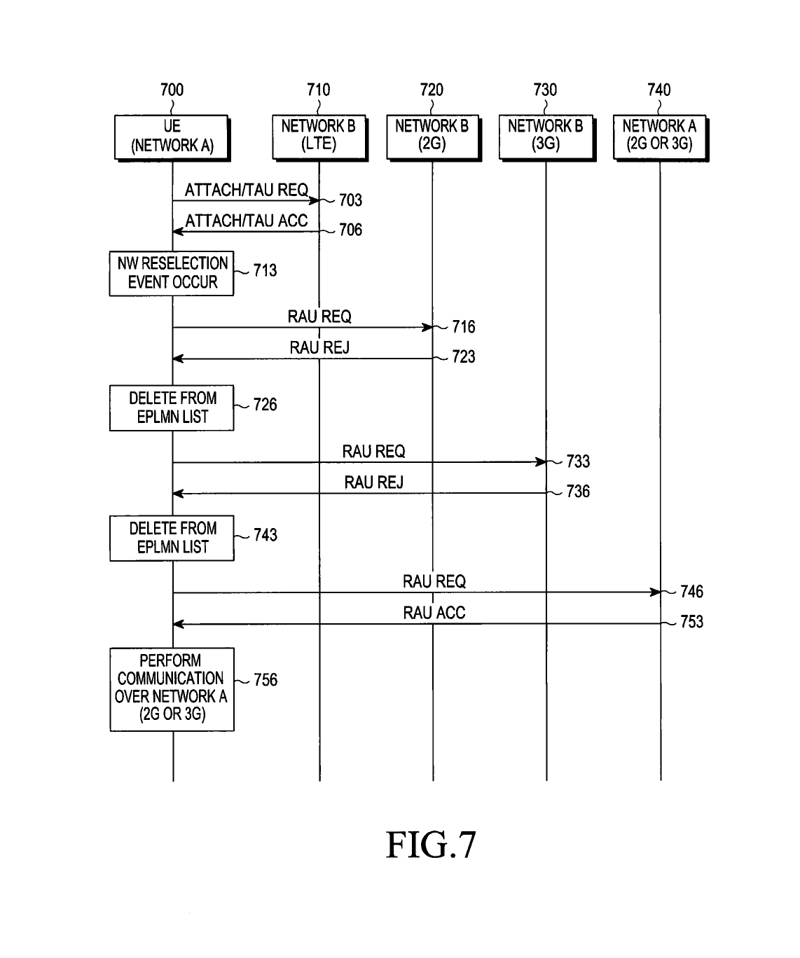

FIG. 7 is a signal flow diagram illustrating operations to prevent a delay in reselecting a network according to an embodiment of the present disclosure. Specifically, FIG. 7 illustrates operations that prevent a delay in reselecting a network, wherein a UE deletes information about a RAT for which no agreement is made, from a network attachment list. For example, the operations in FIG. 7 are applicable when a UE has not received information about a RAT for which a roaming agreement is made, from the network operator A or network operator B (or network operator C).

Referring to FIG. 7, a communication device, e.g., the communication device 300, of the UE 700 controls the UE 700 to receive a network attachment list including information about a network (e.g., the network B) for which there is a roaming agreement, from the network operator A or network operator B. For example, the network attachment list may be an EPLMN list including PLMN IDs, e.g., “45005” and “45006”, of networks that may be accessed by the UE 700, e.g., the network A and network B.

Upon reception of the network attachment list, the UE 700 adds a RAT supported by the UE 700 (or provided by the user) to the EPLMN list and stores the EPLMN list in a storage module, e.g., the memory 303 or a separate memory. For example, the network attachment list to which the RAT information is added may be stored as “network A (45005)—LTE, network A (45005)—UMTS, network A (45005)—GMS, network B (45006)—LTE, network B (45006)—UMTS, network B (45006)—GMS”.

In FIG. 7, the UE 700 fails to receive information about a roaming agreement for a RAT between the network operators A and B.

In operation 703, the UE 700 requests attachment to an LTE network 710 of the network B.

In operation 706, the UE 700 receives an acceptance response from the network B.

After the UE 700 is attached to the LTE network 710 of the network B, a network reselection event occurs for the UE 700 in operation 713.

After the network reselection event, the UE 700 sends a RAU request (RAU REQ) message to a 2G network 720 of the network B in operation 716.

In operation 723, the UE 700 receives a rejection response (RAU REJ) message from the 2G network 720 of the network B. The rejection response (RAU REJ) message indicates that no roaming agreement has been made between the network operators A and B for the 2G network 720 of the network B.

Although not illustrated, after receiving the rejection response in operation 723, the UE 700 may repeatedly send RAU request (RAU REQ) message a predetermined number of times, e.g., three times. After receiving the rejection response (RAU REJ) message in operation 723 or when the rejection response (RAU REJ) message has been received more than the predetermined number of times, the UE 700 deletes the 2G network 720 of the network B from the network attachment list, i.e., the EPLMN list, in operation 726.

In operation 733, the UE 700 sends a RAU REQ message to a 3G network 730 of the network B.

In operation 736, the UE 700 receives a rejection response (RAU REJ) message from the 3G network 730 of the network B. The rejection response (RAU REJ) message indicates that no roaming agreement is made between the network operators A and B for the 3G network 730 of the network B.

Although not illustrated, upon receiving the rejection response message in operation 736, the UE 700 may repeatedly send the attachment request (RAU REQ) message a predetermined number of times, e.g., three times.

After receiving the rejection response (RAU REJ) message in operation 736 or when the rejection response (RAU REJ) message has been received more than the predetermined number of times, e.g., three times, the UE 700 deletes the 3G network 730 of the network B from the network attachment list in operation 743.

In operation 746, the UE 700 sends a RAU REQ message to a 2G or 3G network 740 of the network A.

In operation 753, the UE 700 receives an acceptance response (RAU ACC) message from the 2G or 3G network 740 of the network A.

In operation 756, the UE 700 communicates over the 2G or 3G network 740 of the network A.

By deleting RATs for which the rejection response has been received, from the network attachment list, in operations 723 and 726, the UE 700 may now block future attachment to the deleted RATs when a network reselection event occurs, thereby preventing a delay in the network reselection, e.g., as illustrated in FIGS. 4 to 6.

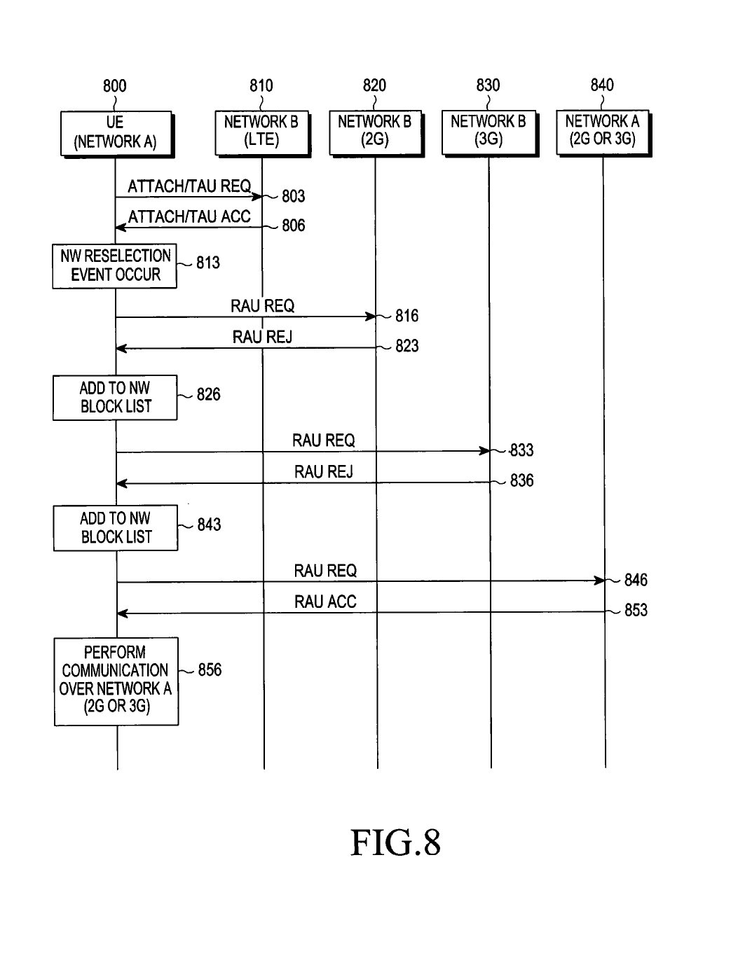

FIG. 8 is a signal flow diagram illustrating operations to prevent a delay in reselecting a network according to an embodiment of the present disclosure. Specifically, FIG. 8 illustrates operations that prevent a delay in reselecting a network by creating a network block list including information about RATs for which no agreements are made.

In FIG. 8, information about a network and RAT corresponding to a rejection response is stored in network attachment block information, when a rejection response has been received, e.g., more than a predetermined number of times. For example, the network attachment block information may include a list of PLMN IDs and RAT information of the network. A storage module (e.g., the memory 303 or a separate memory) may separately store a network attachment list including PLMN IDs and a network block list including the PLMN IDs and RAT information. For example, the network attachment list may be stored as “network A (45005), network B (45006)”, and the network block list may be stored as “network B (45006)—LTE, network B (45006)—UMTS, network B (45006)—GSM” including network types, i.e., RAT information.

Referring to FIG. 8, operations 803 to 823 are the same as operations 703 to 723 in FIG. 7. Accordingly, a reparative description of operations 803 to 823 is omitted.

After receiving the rejection response in operation 823, or more than the predetermined number of times, the UE 800 adds information about the 2G network 820 of the network B to the network block list in operation 826. That is, different than operation 726 of FIG. 7, which deletes information about the 2G network 720 of the network B from the EPLMN list, operation 826 in FIG. 8 adds the information about the 2G network 820 of the network B to the network block list.

In operation 833, the UE 800 sends a RAU REQ message to a 3G network 830 of the network B, and in operation 836, the UE 800 receives a rejection response from the network B, which indicates that no roaming agreement has been made between the network operators A and B for the 3G network 830 of the network B.

After receiving the rejection response in operation 836, or a predetermined number of times, the UE 800 adds information about the 3G network 830 of the network B to the network block list in operation 843.

In operation 846, the UE 800 sends a RAU REQ message to a 2G or 3G network 840 of the network A, and in operation 853, the UE 800 receives an acceptance response message from the 2G or 3G network 840 of the network A.

In operation 856, the UE 800 communicates over the 2G or 3G network 840 of the network A.

By adding information about RATs from which the rejection responses have been received, to the network block list, in operations 826 and 843, the UE 800 may block future attempts for attachment to the RATs added to the network block list, when a network reselection event occurs, thereby preventing a delay in the network reselection.

Under the control of a communication device, e.g., a communication device 300 as illustrated in FIG. 3A, various functions or operations performed by the UEs 310, 400, 500, 600, 700, and 800 may also be controlled by an AP included separately from the communication device 300 in the UE. That is, various functions or operations performed by the UEs illustrated in FIGS. 3B, 4, 5, 6, 7, and 8 may be controlled by a communication device therein, e.g., a processor 310, or in cooperation of the processor 310 and the AP, or by the AP alone.

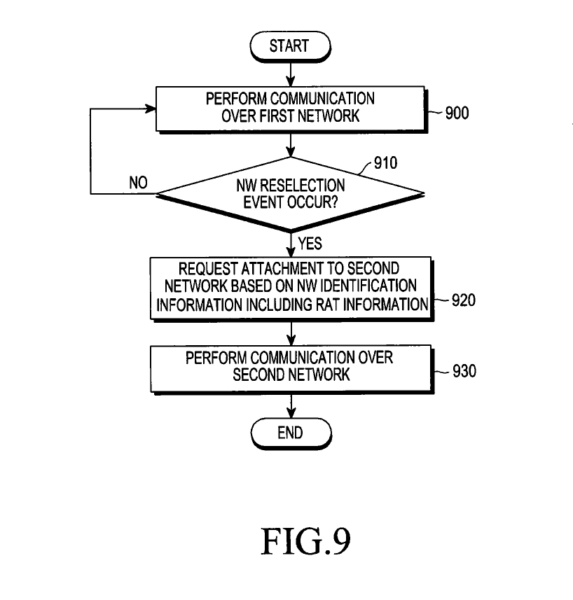

FIG. 9 is a flowchart illustrating a method for controlling a UE according to an embodiment of the present disclosure.

Referring to FIG. 9, in step 900, a UE communicates over a first network.

In step 910, the UE determines whether a network reselection event has occurred.

If it is determined that the network reselection event has not occurred in step 910, the method returns to step 900. However, it is determined that the network reselection event has occurred in step 910, the UE requests attachment to a second network, based on network identification information including RAT information, in step 920. For example, the UE may check network identification information including RAT information in an EPLMN list or a network block list.

In step 930, the UE communicates over the second network. Notably, there is little delay between steps 910 and 930, because the UE requests attachment to a second network, based on network identification information including RAT information, in step 920, i.e., request attachment to a second network to which there is an agreement.

The operations described in connection with a UE above in accordance with the various embodiments of the present disclosure may be equally applied to a method for controlling the UE, e.g., by a communication device 300 thereof.

At least a part of a UE and/or a communication device (or the operation(s) or function(s) performed by the UE and/or communication device) or method may be implemented by instructions stored in a computer-readable storage medium, e.g., in the form of a program module. The instructions, when executed by one or more processors (e.g., the processor 302), may cause the processor to carry out a corresponding function. The computer-readable storage medium may be, e.g., the memory 303.

The computer-readable storage medium may include a hard disk, a floppy disk, a magnetic medium (e.g., magnetic tape), an optical medium (e.g., Compact Disc Read Only Memory (CD-ROM), Digital Versatile Disc (DVD), magneto-optical medium, such as a floptical disk), a hardware device (e.g., ROM, Random Access Memory (RAM), flash memory, etc.). Examples of the program instructions may include machine language codes and also high-level language codes which are executable by various computing means using an interpreter. The aforementioned hardware devices may be configured to operate as one or more software modules to carry out various embodiments of the present disclosure, and vice versa.

The UE, the method for controlling the UE, the program module in accordance with various embodiments of the present disclosure may include at least one or more of the aforementioned components, or include fewer or more components than the components described above. Operations performed by the UE, the program module or other components in accordance with various embodiments of the present disclosure may be carried out sequentially, simultaneously, repeatedly, or heuristically. Further, some of the operations may be performed in a different order, or omitted, or include other additional operation(s).

Embodiments as described in the specification are provided for the purpose of describing and understanding of technical concept of the present disclosure. Accordingly, the scope of the present disclosure should be construed as including all the modifications or other various embodiments based on the technical idea of the present disclosure.

According to embodiments of the present disclosure, a delay that may occur in scanning and selecting a new PLMN may be prevented by blocking (or not attempting) attachment to a RAT for which no agreement has been made between network operators in offering a roaming service.

While the disclosure has been shown and described with reference to certain embodiments thereof, it will be understood by those skilled in the art that various changes in form and details may be made therein without departing from the spirit and scope of the disclosure as defined by the appended claims and their equivalents.

1. A communication device in a mobile communication system, the communication device comprising:
a memory configured to store network identification information, the network identification information including information about a Radio Access Technology (RAT) corresponding to a type of a network;
a transceiver; and
a processor configured to control the transceiver, in response to a network reselection event while the communication device is connected to a first network, to connect the communication device to a second network based on the network identification information.

2. The communication device of claim 1, wherein the network identification information further includes at least one of:
a network attachment list identifying networks to which the communication device attach to; and
a network block list identifying networks to which the communication device cannot attach to.

3. The communication device of claim 2, wherein the network attachment list includes information about an Equivalent Public Land Mobile Network (EPLMN) for the communication device.

4. The communication device of claim 1, wherein the processor is further configured to control the transceiver, in response to the network reselection event, to attach the communication device to the second network, based on a type of the second network that corresponds to the information about the RAT.

5. The communication device of claim 2, wherein the network attachment list includes a type of the second network supportable by the communication device.

6. The communication device of claim 5, wherein the processor is further configured to control the transceiver to send, to a management server of the second network, a request for attachment to the type of the second network.

7. The communication device of claim 6, wherein the processor is further configured to delete the type of the second network from the network attachment list, and add the type of the second network to the network block list if a rejection message in response to the request for attachment has been received a predetermined number of times.

8. A method for controlling a communication device in a mobile communication system, the method comprising:
identifying a network reselection event while the communication device is connected to a first network; and
requesting attachment to a second network based on network identification information stored in the communication device, in response to the network reselection event,
wherein the network identification information includes information about a Radio Access Technology (RAT) corresponding to a type of a network.

9. The method of claim 8, wherein the network identification information further includes at least one of:
a network attachment list identifying networks to which the communication device may attach to; and
a network block list identifying networks to which the communication device cannot attach to.

10. The method of claim 9, wherein the network attachment list includes information about an Equivalent Public Land Mobile Network (EPLMN) for the communication device.

11. The method of claim 8, wherein requesting attachment to the second network comprises requesting attachment to the second network based on the type of the second network that corresponds to the information about the RAT.

12. The method of claim 9, wherein the network attachment list further includes information about a type of the second network supportable by the communication device.

13. The method of claim 12, further comprising sending, to a management server of the second network, a request for attachment to the type of the second network, in response to the network reselection event.

14. The method of claim 13, further comprising:
deleting the type of the second network from the network attachment list, if a rejection message in response to the request for attachment has been received a predetermined number of times; and
adding the type of the second network to the network block list.

15. A system on chip (SoC) for use in a user equipment (UE) in a mobile communication system, the SoC comprising:
a memory configured to store network identification information, the network identification information including information about a Radio Access Technology (RAT) corresponding to a type of a network;
a transceiver; and
a processor configured to control the transceiver, in response to a network reselection event while the UE is connected to a first network, to connect the UE to a second network based on the network identification information.

16. The SoC of claim 15, wherein the network identification information further includes at least one of:
a network attachment list identifying networks to which the UE can attach to; and
a network block list identifying networks to which the UE cannot attach to.

17. The SoC of claim 16, wherein the processor is further configured to block the transceiver, in response to a network reselection event while the UE is connected to a first network, from attempting a connection of the UE to a third network based on the network block list.

18. The SoC of claim 16, wherein the processor is further configured to control the transceiver to send, to a third network, a request for attachment to the third network, in response to the network reselection event.

19. The SoC of claim 18, wherein the processor is further configured to delete the third network for which the request for attachment was made, from the network attachment list, if a rejection message in response to the request for attachment has been received a predetermined number of times.

20. The SoC of claim 18, wherein the processor is further configured to add the third network for which the request for attachment was made, to the network block list, if a rejection message in response to the request for attachment has been received a predetermined number of times.
